(19) United States
(12) Patent Application Publication
(10) Pub. No.: US 2005/0008344 A1
(43) Pub. Date: Jan. 13, 2005

(54) Digital system for recording video signals

(75) Inventor: Henri Crohas, Verrieres Le Buisson (FR)

Correspondence Address: YOUNG & THOMPSON, 745 SOUTH 23RD STREET, 2ND FLOOR, ARLINGTON, VA, 22202, US

(73) Assignee: ARCHOS, IGNY (FR)

(21) Appl. No.: 10/637,491

(22) Filed: Aug. 11, 2003

(30) Foreign Application Priority Data
Jul. 11, 2003 (FR) 03 08516

(51) Int. Cl. H04N 5/91; H04N 7/00; H04N 1/00

(52) U.S. Cl. 386/124; 386/46

(57) ABSTRACT

The invention relates to a system for recording audio/video signals. This system comprises an audio/video signals receiving module, capable of receiving analogue and digital signals, this module being provided with means of conversion of the received signals. It also comprises a storage unit for recording, in digital form, the audio/video signals coming from the said conversion means in response to a record instruction. According to the invention, the storage unit is an autonomous portable player integrated in a removable manner in the said receiving module and comprising: digital storage means, means for reproducing the recorded signals, means for displaying and/or listening to the recorded audio/video signals, and autonomous power supply means rechargeable within the said receiving module.

The present invention relates to a system for recording video signals in digital form. It relates in particular to terminals of the “Set-top-box” type receiving a flow of data from a cable or an antenna.

There are numerous devices for recording digital video signals which are connected to the set-top-box. The document U.S. Pat. No. 6,442,328 describes a set-top-box connected, on the one hand, in a digital manner to a digital recorder provided with a hard disk and, on the other hand, to a television set. The television set can thus be fed in real time with a signal coming from the hard disk and by the TV signal received by the set-top-box. The means of connection between the digital recorder and the set-top-box are such that the stored audio/video sequences are difficult to transport.

Furthermore, set-top-box terminals exist which are provided with an integrated hard disk. The received digital signal can thus be recorded directly in digital form. In order to be able to share the recorded audio/video sequences, such terminals comprise an Internet connection. However, the transfer of a bulky video file via the Internet is still laborious because of the limited bandwidth.

In order to improve the portability of the recorded video sequences, devices are known that record on removable media such as a CD or a DVD. The document WO 03030594 describes a set-top-box integrating a hard disk and a CD drive/burner making it possible to improve the portability of the stored video signal since the recorded CD or DVD can be transported easily and read by many other devices. The recording capacity is also increased artificially since it suffices to replace the full CD or DVD with a blanc CD or DVD. The document WO 0184826 is

also known which describes an on-demand video system in the form of a set-top-box associated with integrated or removable storage means such as a CD or a DVD. The use of two tuners makes it possible to record one channel whilst displaying another. The portability is also limited by the fact that the sequences are stored in a removable CD or DVD.

The objective of the present invention is a new digital video recording system in which the portability of the recorded audio/video sequences is greatly improved.

Said objective is achieved with a system for recording audio/video signals, this system comprising:
an audio/video signals receiving module, capable of receiving analogue and digital signals, this module being provided with means of conversion of the received signals, and
a storage unit for recording, in digital form, the audio/video signals coming from the said conversion means in response to a record instruction.

According to the invention, the storage unit is an autonomous portable player integrated in a removable manner in the receiving module. The receiving module therefore comprises a housing adapted to receive the portable player.

According to a preferred embodiment of the invention, the portable player comprises:
digital storage means,
means for reproducing the recorded signals,
means for displaying and/or listening to the recorded audio/video signals, and
autonomous power supply means rechargeable within the receiving module.

The receiving module can therefore advantageously comprise connection means for recharging the autonomous power supply means of the portable player.

The receiving module can be of the set-top-box type provided with a processing unit such as a microcontroller or a microprocessor.

The system according to the invention therefore comprises two parts, a base or cradle, in the form of a receiving module installed close to video sources and connected to all of the audio/video apparatuses of the house and to the available audio/video sources and a second part in the form of an autonomous portable player comprising a battery, storage means (preferably a hard disk) for storing the signals coming from the base, and reproducing means such as for example a digital-analogue converter, a video decoder, a screen and loudspeakers. The hard disk is of large capacity and can store up to about fifty hours of video sequences. Technological development will of course make it possible to integrate hard disks of even greater capacity.

The receiving module and the portable player can comprise metal connection means for communication.

According to one embodiment of the invention, the portable player comprises means of wireless communication with the receiving module. In this case, it is not necessary to insert the portable player into the receiving module, the sequences to be recorded being able to be transmitted remotely and by wireless means. The housing in the receiving module is then used for inserting the portable player into it in order to recharge the battery.

The wireless communication can therefore be carried out whether or not the portable player is inserted. It is possible to provide a portable player provided with both a metal connector and with a wireless module, the communication taking place automatically by means of the metal connector when the portable player is inserted and by means of the wireless module when the portable player is out of the housing whilst remaining

within the range of a second wireless module installed in the receiving module.

In wireless communication of the WiFi type (wireless communication standard 802.11) for example, the portable player can be used as a WiFi remote control for controlling the receiving module.

According to an advantageous characteristic of the invention, the portable player comprises an inputting interface in the form of a touch screen, which can be used as a means for the absolute selection of an object or of a menu displayed on the integrated screen with the user's finger (“touch screen function), and which can be used as a mouse pointer of the “touch pad” type when the display is on a TV screen (OSD). In the later case, the position and movement information of the user's finger are converted into data on the movement and speed of a pointer on the screen in order to simulate the typical mouse interface of a portable PC.

The receiving module can comprise an infrared module for receiving data from a standard IR remote control and possibly for transmitting it to the portable player. The user can control the majority of the functions of the assembly (receiving module+inserted portable player) with this standard remote control: adjustments, recording programming.

According to an advantageous embodiment of the invention, for hertzian television signals for example, the portable player comprises at least one tuner. The system as a whole can comprise a single tuner which is either arranged in the receiving module, in which case the receiving module can be used alone, or it can be arranged in the portable player, in which case the receiving module can be used only with its portable player. The system as a whole can also comprise a tuner arranged in the receiving module and a tuner arranged in the portable player.

Advantageously, the conversion means in the receiving module can comprise:
a hertzian tuner associated with an audio demodulator for processing analogue signals coming from a TV antenna connected to an input of the receiving module;
a radio tuner for processing analogue signals coming from a radio antenna connected to an input of the receiving module, both of these tuners making it possible to obtain analogue signals in baseband;
means of decoding digital TV signals received by the receiving module, for example these means make it possible to convert MPEG-2 digital signals into non-compressed digital signals in the CCIR-656 format (Recommendation Number 656 of the “Comité Consultatif International des Radiocommunications (CCIR), henceforth called ITU (International Telecommunication Union), giving the abbreviation “ITU-R 656”);
means of converting digital video signals received by the receiving module, in particular coming from a digital video camera with a specific MPEG-2 format, into a format such as the digital CCIR one compatible with the storage module; and
an analogue-digital converter for converting analogue signals received by the receiving module into digital signals, in the CCIR-656 format for example, that can be transmitted to the portable player.

The conversion means are fed by various sources and generate digital output signals that can be transmitted to the portable player.

The system according to the invention is therefore a multi-source system: hertzian TV, cable TV, FM radio, DV digital video and analogue video. Those skilled in the art will easily understand that this list is not exhaustive.

According to a variant of the invention, the analogue-digital converter is arranged in the portable player in order to convert analogue signals coming from the receiving module into digital signals intended to be stored. The portable player furthermore comprises an analogue input associated with this analogue-digital converter for receiving the analogue signals coming from the receiving module, and a digital input via a connector adapted to receive the digital signals coming from the receiving module.

Advantageously, the portable player can comprise digital compression means for compressing the digital audio/video signals intended to be stored. This can be an MPEG-4 or Divx format encoder.

Preferably, the portable player comprises conversion means capable of converting the stored digital audio/video signals into audio/video signals that can be read by external reproducing terminals, and connection means capable of transmitting the stored signals from the portable player to external reproducing terminals. This player can thus be connected alone directly to a television set or to a Hi-fi system or to any other audio/video apparatus.

According to one embodiment of the invention, the record instruction comes from a remote control device. It can also come from programming stored within the receiving module or from programming stored within the portable player.

Other advantages and characteristics of the invention will appear on examining the detailed description of an embodiment that is in no way limitative and of the appended drawings in which:

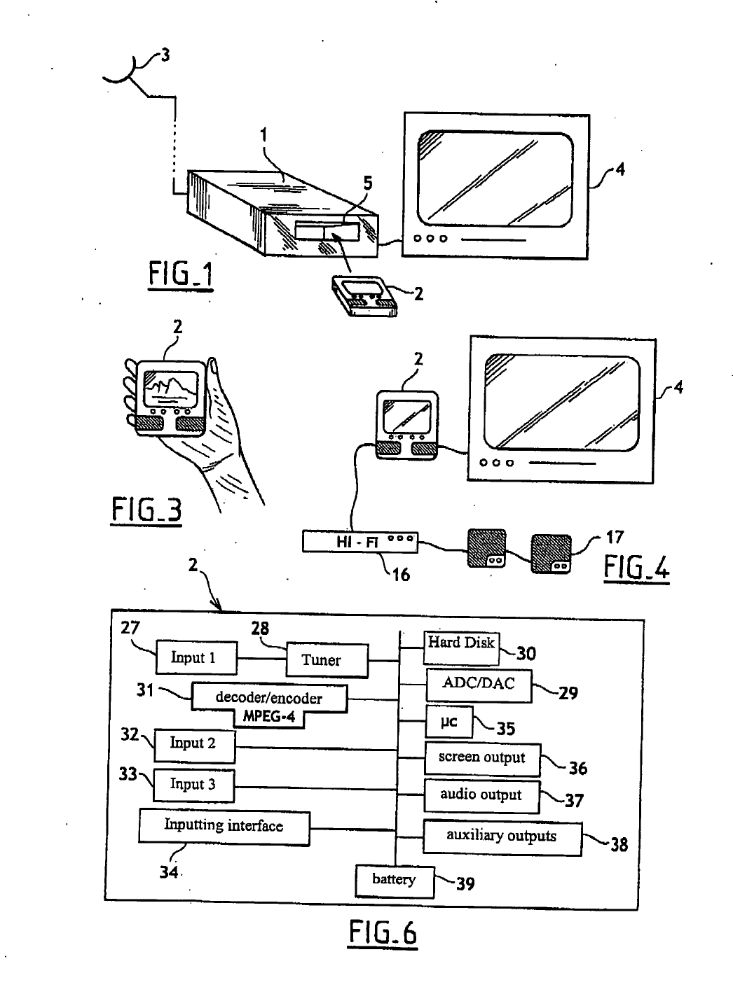

FIG. 1 is a general view of the system according to the invention;

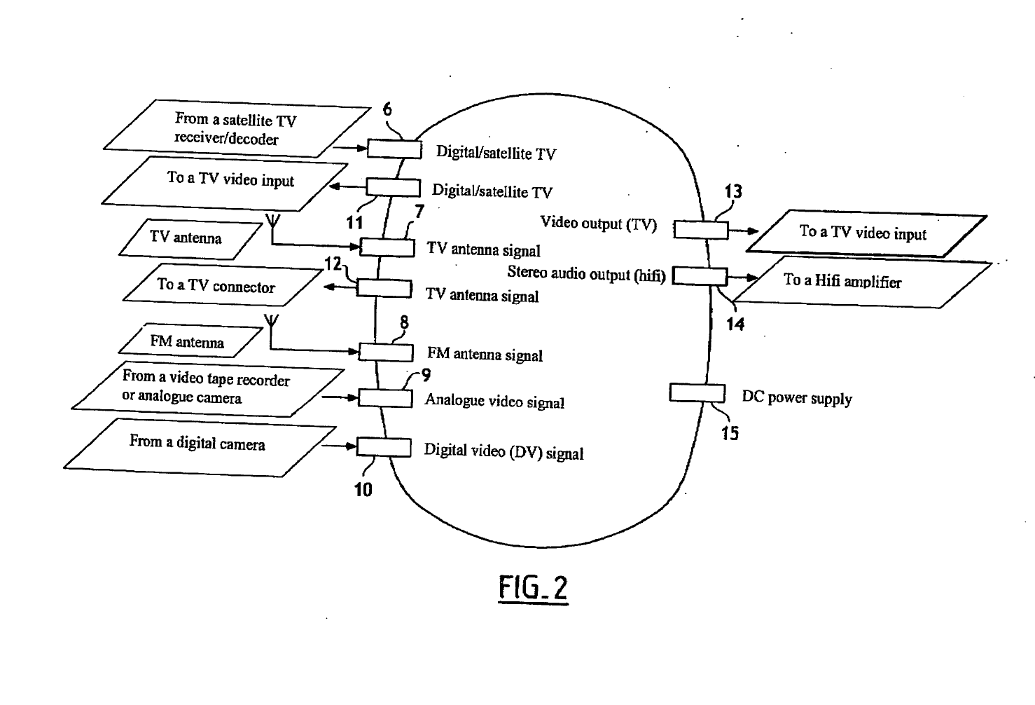

FIG. 2 is a diagram illustrating various ways of using a receiving module or set-top-box according to the invention;

FIG. 3 is a view illustrating a method of using the portable player according to the invention;

FIG. 4 is a block diagram illustrating the association of a portable player according to the invention with a television set and a Hi-fi amplifier;

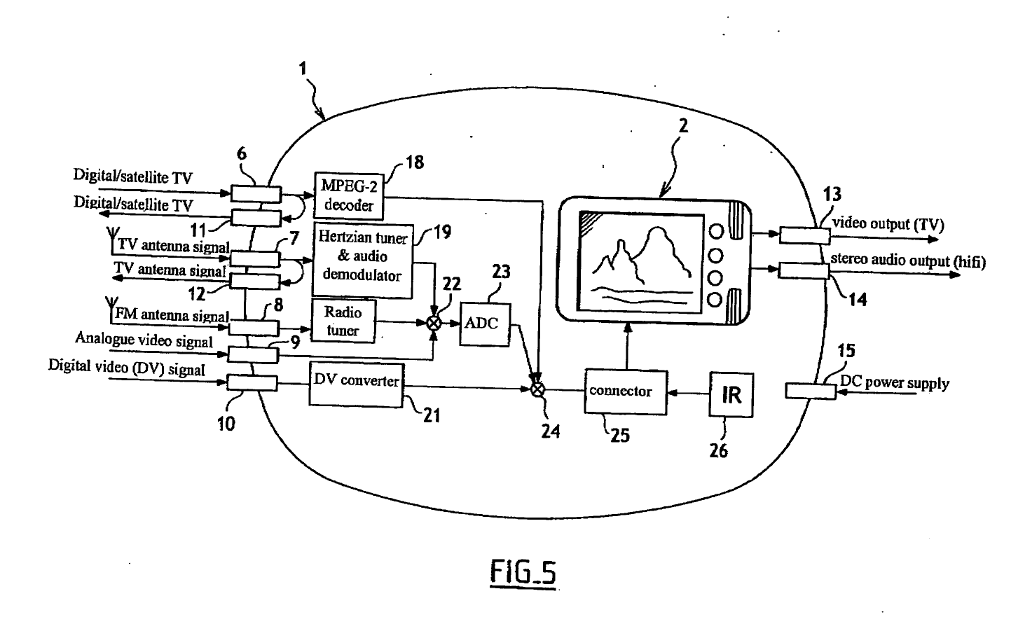

FIG. 5 is a simplified diagram of the portable player integrated in the receiving module and of some components of this receiving module; and

FIG. 6 is a simplified block diagram illustrating some internal components of the portable player according to the invention.

With reference to FIG. 1, there can seen a video system according to the invention comprising a receiver 1 and an autonomous removable portable player 2. The receiving module 1 according to the invention is of the set-top-box type. When an incoming video signal is encrypted, the receiving module 1 comprises means of decrypting it. As will be seen in greater detail below, the receiving module also comprises means of digitising the analogue video signals before storing them on a hard disk. The invention is particularly noteworthy in that the hard disk provided for storing the digitised video signal is arranged in the portable player 2. In order to select a source, program a recording or, in general, to configure the system according to the invention, it is possible to use an inputting interface of the receiving module (buttons associated with a display module arranged on a panel), a standard infrared remote control or the touch screen of the portable player. During the configuration of the system, a display of the OSD (On Screen Display) type appears on the screen of the television set.

The receiving module 1 can function in a conventional manner for a set-top-box, that is to say it can receive a video signal coming from an external source

and feed a television set 4 with or without the presence of the portable player 2. However, the system according to the invention is a multi-source system and it is provided with a recording function which, when is it controlled, makes it possible to record a given digital video signal from a given source on the hard disk of the autonomous portable player 2.

The portable player 2 is inserted into the receiving module 1 for the recording. Metal connection means provided on the portable player 2 and the receiving module 1 cooperate with each other in order to allow the exchange of data between the two apparatuses. Metal connection means are also provided for recharging a battery arranged in the portable player 2 from a power supply source of the fixed receiving module 1.

Furthermore, the receiving module 1 and the portable player 2 can communicate by wireless means. In order to do this, they integrate wireless modules of the WiFi (Wireless Fidelity) type, corresponding to the 802.11 wireless communication standard. The housing 5 and the mechanical connection means between the receiving module 1 and the portable player 2 are used to allow the recharging of the battery when the portable player 2 is inserted in the housing 5.

The portable player 2 can also serve as a WiFi remote control for the receiving module 1. The functions to be remote-controlled can for example be the selection of a channel to be displayed in real time or to be recorded, the volume level, the switching on and putting on standby of the receiving module 1 or even the programming of the recording. This programming can be stored within a processing unit of the receiving module 1 or within a processing unit of the portable player 2.

When a transmission has been recorded on a hard disk of the portable player 2, it can be displayed at any time by means of the portable player 2 alone as seen in FIG. 3. This player comprises display and sound reproducing means as well as a power supply battery in order to be completely autonomous. The recorded transmission thus becomes easily transportable and accessible at any time and at any place from the portable player 2. With a high capacity hard disk and constantly evolving compression algorithms, several tens of hours of film can be stored.

The recorded transmission can therefore be displayed away from home, for example during a journey, in an entirely autonomous manner, or at home by means of any fixed television set 4 and/or HiFi amplifier 16 provided with loudspeakers 17 for greater comfort.

FIG. 2 shows a simplified block diagram of a way of using the receiving module 1 according to the invention. This receiving module 1 comprises several inputs such as a satellite input 6 for receiving the digital signal coming from a digital decoder connected to a satellite antenna, an analogue input 7 connected to an antenna receiving hertzian TV signals, an analogue input 8 connected to an antenna receiving hertzian FM radio signals, an analogue input 9 receiving the analogue signals coming from an analogue camera, and a DV digital input 10 receiving digital signals coming from a digital camera.

The signal arriving through the satellite input 6 can be redirected to the satellite output 11 for feeding a television set. Similarly, the signal arriving through the analogue input 7 can be sent directly to the analogue output 12 connected to a television set.

The receiving module 1 according to the invention also comprises a video output to be connected to a television set in such a way as to transmit the video signal coming from the portable player 2. Similarly, a stereo audio output can be seen for connecting to a HiFi amplifier in such a way

as to transmit the audio signal coming from the portable player 2 to an external terminal. A power supply connector 15 can also be seen, which is intended for recharging the portable player 2 when the latter is inserted in the receiving module 1.

In FIG. 5, several internal elements of the receiving module 1 in which portable player 2 is integrated can be seen in a more detailed but non-limitative manner.

The same inputs and outputs as those shown in FIG. 2 can again be seen. The signals coming from the various inputs 6, 7, 8, 9 and 10 can be stored in digital form on a hard disk contained in the portable player 2. Different compression formats can be used for storing a large quantity of video signals on the hard disk. In particular it is possible to use the MPEG-2 format, the MPEG-4 format or even the DIVX format.

The decoder 18 makes it possible to convert the MPEG-2 digital signals coming from the input 6 into a decompressed digital signal in CCIR656 format, this signal then being transmitted to the portable player 2 for compression and recording. Similarly, the module 21 makes it possible to convert digital signals, coming for example from a digital camera via the input 10, into a decompressed digital signal in CCIR656 format.

As regards the analogue signals, an analogue-digital converter 23 is used which delivers a non-compressed digital signal of the CCIR656 type. This analogue-digital converter is preceded by a multiplexer 22 directly receiving:
an analogue video signal via the input 9,
an analogue signal coming from a radio tuner 20 fed by the analogue radio signal from input 8, and
an analogue signal coming from a tuner 19 fed by an analogue hertzian television signal, the tuner 19 consisting of a hertzian tuner and an audio demodulator.

The multiplexer 24 is capable of conveying one of the non-compressed digital signals from the modules 18, 21 and 23 to the hard disk of the portable player 2 via a connector 25. This connector 25 comprises an interface of the compact flash® type cooperating with a corresponding connector arranged in the portable player 2. The interface between the connector 25 and the multiplexer 24 consists of a digital video bus of the CCIR656 type and a control bus 12C. This connector 25 also comprises an infrared input receiving the signals from an infrared receiver 26.

FIG. 6 is a simplified and non-limitative block diagram illustrating some internal components of the portable player 2 according to the invention. The core of the portable player 2 consists of a microcontoller 35 for processing data and for coordinating the various components. A first input 27 can be seen, which can receive a video signal coming from a hertzian TV antenna. Such a signal is then processed by a tuner 28 and then an analogue to digital converter 29. The digital signal obtained is in the non-compressed CCIR656 format and can then be compressed into MPEG-4 or Divx and then recorded on the hard disk 30. However, the signal coming from the tuner 28 can be conveyed to one of the auxiliary outputs 38 in order to feed a television set and/or an external Hi-Fi amplifier.

The input 32 is the one that is engaged with the connector 25 of the receiving module 1.

The input 33 is a digital input receiving signals coming from a digital camera for example.

The digital signals arriving through the inputs 32 and 33 are firstly compressed into MPEG-4 format by the decoder/encoder 31 before being stored on the hard disk 30.

The audio/video signals stored on the hard disk 30 can be retrieved via a display screen 36 and an audio output 37, in such a way that the user of the portable player 2 can display the transmissions stored on the hard disk 30 at any place and at any time.

The whole of the portable player is powered by means of an internal battery 39 which can be recharged when the portable player 2 is inserted in the receiving module 1.

There can also be seen an inputting interface 34 which makes it possible to set up and control various functions of the portable player 2 such as the programming of the recordings, the playing back of video sequences and the selection of an input. The inputting interface 34 can be associated with the screen 36 in the form of a touch screen.

When the portable player 2 is connected to a television set via one of the auxiliary outputs 38, the video sequences stored on the hard disk 30 are firstly decompressed via the module 31 and then converted into an analogue signal via the module 29. The invention is not of course limited to the examples that have just been described and many developments can be applied to these examples without departing from the scope of the invention.

1. System for recording audio/video signals comprising:
an audio/video signals receiving module (1), capable of receiving analogue and digital signals, this module being provided with means of conversion of the received signals,
a storage unit (2) for recording, in digital form, the audio/video signals coming from the said conversion means in response to a record instruction;
characterized in that the said storage unit is an autonomous portable player integrated in a removable manner in the said receiving module.

2. System according to claim 1, characterized in that said portable player comprises:
digital storage means (30),
means (38) for reproducing the recorded signals,
means (36, 37) for displaying and/or listening to the recorded audio/video signals, and
autonomous power supply means (39) rechargeable within said receiving module.

3. System according to claim 1, characterized in that the receiving module and the portable player comprise metal connection means for communication.

4. System according to claim 1, characterized in that the portable player comprises means of wireless communication with said receiving module.

5. System according to claim 1, characterized in that the portable player comprises an inputting interface in the form of a touch screen.

6. System according to claim 5, characterized in that the said touch screen is used as a means for the absolute selection of an object displayed on the said screen, which corresponds to the so-called “touch screen” function.

7. System according to claim 5, characterized in that the said touch screen is used like a mouse pointer when the display is produced on a television screen, which corresponds to the so-called “touch pad” function.

8. System according to claim 1, characterized in that the storage means comprise a hard disk.

9. System according to claim 1, characterized in that the portable player comprises at least one tuner (28).

10. System according to claim 1, characterized in that the conversion means comprise a hertzian tuner (19) associated with an audio demodulator for processing analogue signals coming from a TV antenna connected to an input of the receiving module.

11. System according to claim 1, characterized in that the conversion means comprise a radio tuner (20) for processing analogue signals coming from a radio antenna connected to an input of the receiving module.

12. System according to claim 1, characterized in that the conversion means
comprise means (18) of decoding digital TV signals received by the receiving module.

13. System according to claim 1, characterized in that the conversion means comprise means (21) for converting digital video signals received by the receiving module into a format that is compatible with the storage module.

14. System according to claim 1, characterized in that the conversion means comprise an analogue-digital converter (23) for converting analogue signals received by the receiving module into digital signals that can be transmitted to the portable player.

15. System according to claim 1, characterized in that the portable player comprises an analogue-digital converter for converting analogue signals coming from the receiving module into digital signals intended to be stored, said portable player furthermore comprising an analogue input associated with the said analogue-digital converter for receiving the analogue signals coming from the receiving module, and a digital input via a connector adapted to receive the digital signals coming from the receiving module.

16. System according to claim 1, characterized in that the portable player comprises digital compression means (31) for compressing the digital audio/video signals intended to be stored.

17. System according to claim 1, characterized in that the portable player comprises conversion means (29, 31) capable of converting the stored digital audio/video signals into audio/video signals that can be read by external reproducing terminals.

18. System according to claim 17, characterized in that the receiving module comprises connection means (13, 14) capable of transmitting the stored signals from the portable player to external reproducing terminals (4, 16)

19. System according to claim 1, characterized in that the receiving module comprises an infrared module (26) for receiving infrared commands and transmitting them to the portable player.

20. System according to claim 1, characterized in that said record instruction comes from a remote control device.

21. System according to claim 1, characterized in that said record instruction comes from programming stored within the receiving module.

22. System according to claim 1, characterized in that said record instruction comes from programming stored within the portable player.
